(19) United States
(12) Patent Application Publication
(10) Pub. No.: US 2008/0275877 A1
(43) Pub. Date: Nov. 6, 2008

(54) METHOD AND SYSTEM FOR VARIABLE KEYWORD PROCESSING BASED ON CONTENT DATES ON A WEB PAGE

(75) Inventors: Cary L. Bates, Rochester, MN (US); Brian P. Wallenfelt, Eden Prairie, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/744,235

(22) Filed: May 4, 2007

(51) Int. Cl. G06F 7/08

(52) U.S. Cl. 707/7; 707/E17.002

(57) ABSTRACT

A method for modifying knowledge documents, includes: updating an index based on keyword weights, detecting a page that has not been indexed; parsing the page into structures; associating the structures with dates contained thereof; separating the dates on the page into one or more past and future dates; determining whether the page has undergone changes following the separating of dates; wherein in the event the page has not undergone changes the one or more future dates are checked to determine if one or more of the future dates have become additional past dates, and flagging the structures that contain the one or more additional past dates; and wherein during a keyword analysis of the page the structures associated with the one or more past dates and additional past dates are omitted when determining the keyword weights associated with the page.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to keyword processing, and more particularly to a method and system for a search engine to establish relevancy and weighting for keyword content based on associated dates within a Web page.

2. Description of the Related Art

The vast amounts of information contained on the World Wide Web have established the Internet as a preeminent information and research tool. Several types of search engines have been created to assist in the retrieval of information from the Internet. A search engine is an information retrieval system designed to help find information stored on a computer system, such as on the Internet, inside a corporate or proprietary network (known as an Intranet), or in a personal computer. The search engine allows an individual to ask for content meeting specific criteria (typically those containing a given word or phrase) and retrieves a list of items that match those criteria. This list is often sorted with respect to some measure of relevance of the results. Search engines operate algorithmically, or are a combination of algorithmic and human input. Search engines use regularly updated indexes to operate quickly and efficiently. Some search engines also mine or gather data available in newsgroups, databases, or open directories.

Search engines generally employ web crawlers (also known as Web spiders or Web robots/bots) that are programs or automated scripts, which browse networks such as the Internet in a methodical, automated manner as a means of providing up-to-date data. Web crawlers are mainly used to create a copy of all the visited pages for later processing by a search engine, that will index the downloaded pages to provide fast searches. Crawlers can also be used for automating maintenance tasks on a Web site, such as checking links or validating hyper text markup language (HTML) code. Also, crawlers can be used to gather specific types of information from Web pages, such as harvesting e-mail addresses (usually for spam). A web crawler is one type of bot, or software agent. In general, a web crawler starts with a list of Uniform Resource Identifier/locators (URLs) to visit, called the seeds. As the web crawler visits these URLs, it identifies all the hyperlinks in the page and adds them to the list of URLs to visit, called the crawl frontier. URLs from the frontier are recursively visited according to a set of policies.

When a user enters a search phrase of keywords into a search engine there are two factors that determine which Web pages are returned in a list. One factor is the page rank, which is just a measure of goodness or frequency of page views, and has nothing to do with keywords, and the second factor is the weight associated with the keywords for the given page. The keyword weights are adjusted using factors such has how often a keyword appears on a page, the font used to display the keyword and even how close the keyword is to the top of the page. The search engine uses an equation, which involves both the weight of the keywords used in the query along with the page rank for a given page to compute a match score for that page. The web pages are then sorted by their match scores, and the results presented as the search results. One example equation to compute this match score could be:

Match Score=SUM (of matching keyword weights)×page rank

Many search engines try to determine if a Web page is fresh or stale by whether it has changed in the past year or so. Once a Web page is determined to be stale its level of relevancy or ranking is dropped. However, an inherent problem with looking at the last time a page was changed is that some pages can be years old and still have accurate and relevant data, while others may only be 30 days old and be totally out of date. In other instances, Web pages may contain some valid ‘non-stale’ information, while other parts of the page contain stale information. Therefore, there is a need for a search engine that has the ability to determine the relevancy of information within a Web page based on content and the content's associated dates.

### SUMMARY OF THE INVENTION

Embodiments of the present invention include for updating an index based on keyword weights, wherein the method includes: detecting a page that has not been indexed; parsing the page into structures; associating the structures with dates contained therein; separating the dates on the page into one or more past and future dates; determining if the page has undergone changes following the separating of dates; wherein in the event the page has not undergone changes the one or more future dates are checked to determine if one or more of the future dates have become additional past dates, and flagging the structures that contain the one or more additional past dates; and wherein during a keyword analysis of the page the structures associated with the additional past dates are omitted when determining the keyword weights associated with the page.

A system for updating an index based on keyword weights, the system includes: a series of pages with keywords and dates; a software tool configured for searching the series of pages for keywords and dates; wherein the software tool detects pages that have not been indexed, and parses the page into structures; wherein the software tool associates the structures with dates contained thereof; wherein the software tool separates the dates on the page into one or more past and future dates; wherein on subsequent visits the software tool examines the future dates and flags structures associated with future dates that are now past, and the flagged structures are omitted when determining the keyword weights associated with the page.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a search engine that determines which portions of a Web page are out of date, and reduces the keyword weighting associated with keywords that appear in the out of date sections.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram of an existing keyword search illustrating the interaction between the user and an automated search engine.

FIG. 2 is a schematic diagram of a crawler flow according to an embodiment of the invention.

FIG. 3 is a schematic diagram of a memory data structure illustrating pointers to a source page and the recording of ranges of outdated content within the source page according to an embodiment of the invention.

FIG. 4 is a schematic diagram that illustrates a process of updating the index page based on keyword weighting within dated sections of a source page according to an embodiment of the invention.

The detailed description explains the preferred embodiments of the invention, together with advantages and features, by way of example with reference to the drawings.

### DETAILED DESCRIPTION

Embodiments of the invention provide a method and system for a search engine that more accurately determines which parts of a page are outdated or stale, and reduces the keyword weighting associated with keywords that exist only within the outdated sections. When a search engine crawler detects a page that has not been indexed, the search engine parses the page and separates the dates on the page into past and future dates, with respect to moment in time that the page is being parsed. Subsequently, the search engine crawler makes cyclical visits to the page, to determine if the page has undergone content changes. If the page has remained unchanged, the search engine checks the dates saved in a future section memory location to see how many of them are now past (i.e., became stale). When a date on a page is found to have “gone stale”, embodiments of the invention determine the portion or structure of the page that this stale date is within. This structure could be a paragraph, a list entry, a table entry or a row, and are typically written in HTML. When a subsequent keyword analysis is done on the web page, the stale structure(s) would simply be omitted so that the structures content will not participate in determining the keyword weights associated with the page.

In an additional embodiment, the search engine uses high-level grammar to parse the page for lists, which include dates that are formatted in various ways. The list could be formatted as an actual list using a list index (<UL>) tag. The list could also be a table of dates such that a particular column contains a date and another column contains a description. The list could be text, such that a date comes first followed by a description followed by a break (<BR>) tag (or starting with a paragraph (<P>) tag). If the search engine finds grammar with a repeating pattern where the date is in the same place in the pattern each time, the search engine will examine the text that exists in the entry associated with the date. If the search engine determines that the date has become stale, the search engine will reduce the weight associated with any keywords that exist in that entry. Alternatively, the search engine may simply exclude the text when keyword analysis is done, or consider the entry, but to a lesser degree. For example, the text would only contribute ¼ as much to the determination of the keyword weighting, then it would if it were not stale.

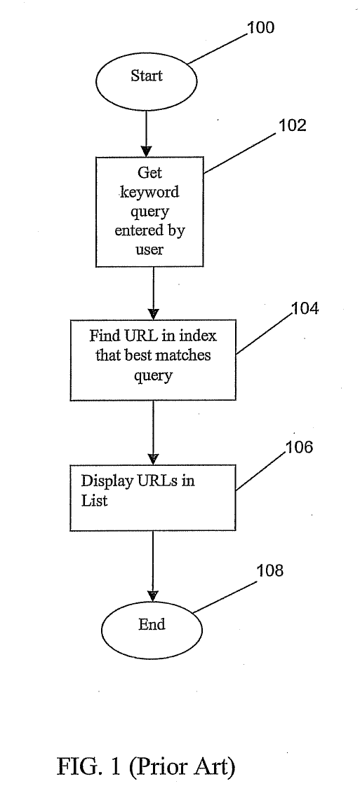

FIG. 1 is a schematic diagram of an existing keyword search illustrating the interaction between the user and an automated search engine. The keyword search begins with a user inputting a keyword (blocks 100/102) in a search engine, and initiating a query of a database or network such as the Internet. The search engine matches the keyword query against an index of URLs (block 104), and displays the URLs that are the best matches to the user keyword query in a list (block 106). The user may then pick a desired URL from the URL list and the search ends at block 108.

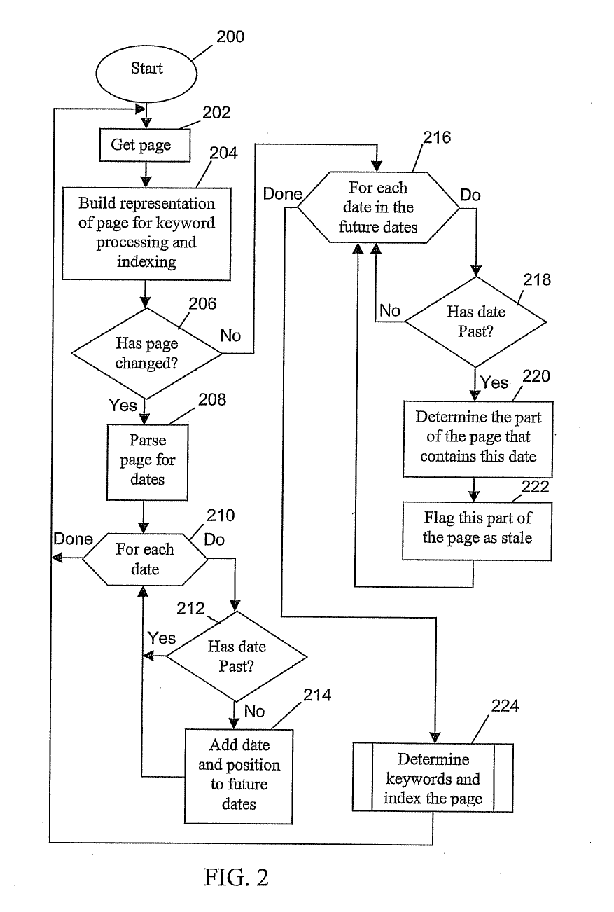

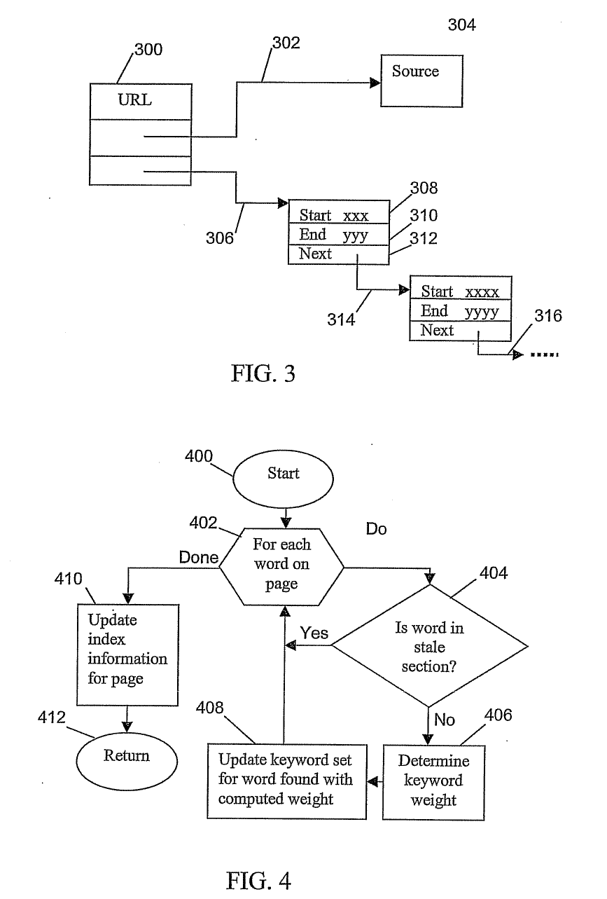

The crawler flow of an embodiment of the invention is described in FIG. 2. The crawler starts (block 202) by getting a page (block 202), and building a data structure in memory with pointers (see FIG. 3) to form a representation of the page for keyword processing and indexing (block 204). The crawler determines if the page has changed since the crawler's last visit (block 206). If the page has had a content change, the crawler parses the page with regards to dates included within structures (block 208) and enters into a for-loop (block 210) that determines if each date is still current or if the date has past (block 212). If the date has not past or expired, the date is added to the list of future dates (block 214) that represent dates for events or expiration periods that have not occurred, or else the keywords associated with the expired date section are discarded. Following completion of the for-loop the crawler at a future point in time returns to the page (block 202) and repeats the investigation of dates within the page.

If the crawler discovers that the page has not undergone a change (block 206) a for-loop (block 216) is carried out for each of the dates stored in the future dates as formed in block 214. If a date has past as determined in block 218, the crawler determines which part of the page is associated with the date (block 220), and this part of the page is flagged as being stale. Following completion of the for-loop (block 216) the keyword weights are determined based on the dates in their associated positions (block 224 and FIG. 4). As before, the crawler at a future point in time returns to the page (block 202) and repeats the investigation of dates within the page.

FIG. 3 is a schematic diagram of a memory data structure illustrating pointers to a source page and the recording of ranges of outdated content within the source page to form a representation of the page for keyword processing and indexing according to an embodiment of the invention. Block 300 represents a data structure in memory associated with a URL with pointers 302 to a source structure 304 on a page being investigated by a crawler. Pointer 306 tracks the start 308 and end 310 positions of an outdated or stale section or structure within a page, while value 312 and pointer 314 tracks the next structure that is stale or outdated. Pointer 316 represents a null pointer and marks the end of the dated content.

FIG. 4 is a schematic diagram illustrating the process (see block 224 of FIG. 2) of updating the index page based on keyword weighting within dated sections of a source page according to an embodiment of the invention. The process starts (block 400) with a for-loop (block 402) for each word on the page that determines if a word is in a section associated with a stale or expired date (block 404). If the word is not associated with a stale date, the keyword weight is determined for the word (block 406), and the keyword set is updated for the word found with the computed weight (block 408). If the word is found to be in a stale section (block 404), no weighting is assigned to the word. Upon completion of the for-loop (block 402), the information index for the page is updated (block 410), and the crawler exits the process (block 412).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A method for updating an index based on keyword weights, the method comprising:
detecting a page that has not been indexed;
parsing the page into structures;
associating the structures with dates contained therein;
separating the dates on the page into one or more past and future dates;
determining whether the page has undergone changes following the separating of dates;
wherein in the event the page has not undergone changes the one or more future dates are checked to determine if one or more of the future dates have become additional past dates, and flagging the structures that contain the one or more additional past dates; and
wherein during a keyword analysis of the page the structures associated with the one or more past additional past dates are omitted when determining the keyword weights associated with the page.

2. The method of claim 1, wherein keywords found in structures associated with the one or more additional past dates are given a smaller weighting than keywords found in structures with future dates that are still current.

3. The method of claim 1, wherein the structures comprise: a paragraph, a list entry, a table entry, a row.

4. The method of claim 1, wherein the structures are written in hypertext markup language (HTML).

5. The method of claim 1, wherein if the page has undergone changes following the separating of dates, the page is parsed again into structures and the dates are separated into one or more past and future dates.

6. The method of claim 1, wherein the index based on keyword weights is updated on a cyclical basis.

7. The method of claim 1, wherein the method is carried out over one or more of the following: newsgroups, databases, open directories, computing devices, intranets, and the Internet.

8. The method of claim 1, wherein the pages are web pages.

9. A system for updating an index based on keyword weights, the system comprising:
a series of pages with keywords and dates;
a software tool configured for searching the series of pages for keywords and dates;
wherein the software tool parses the page into structures;
wherein the software tool associates the structures with dates contained therein;
wherein the software tool separates the dates on the page into one or more past and future dates; and
wherein the software tool determines whether the page has undergone changes following the separating of dates;
wherein in the event the page has not undergone changes the one or more future dates are checked to determine if one or more of the future dates have become one or more additional past dates, and flagging the structures that contain the one or more additional past dates; and
wherein the flagged structures are omitted when determining the keyword weights associated with the page.

10. The system of claim 9, wherein keywords found in structures associated with the one or more additional past dates are given a smaller weighting than keywords found in structures with future dates that are still current.

11. The system of claim 9, wherein the structures comprise: a paragraph, a list entry, a table entry, a row.

12. The system of claim 9, wherein the structures are written in hypertext markup language (HTML).

13. The system of claim 9, wherein if the page has undergone changes following the separating of dates, the software tool parses the page again into structures and the dates are separated into one or more past and future dates.

14. The system of claim 9, wherein the index based on keyword weights is updated on a cyclical basis.

15. The system of claim 9, wherein the software tool is configured for searching the series of pages for keywords and dates in one or more of the following: newsgroups, databases, open directories, computing devices, intranets, and the Internet.
